(19) United States
(12) Patent Application Publication
(10) Pub. No.: US 2013/0017423 A1
(43) Pub. Date: Jan. 17, 2013

(54) ALKALINE SECONDARY BATTERY

(71) Applicants: Machiko TSUKIJI, Osaka (JP); Jun Nunome, Kyoto (JP); Miyuki Nakai, Osaka (JP); Fumio Kato, Osaka (JP)

(72) Inventors: Machiko TSUKIJI, Osaka (JP); Jun Nunome, Kyoto (JP); Miyuki Nakai, Osaka (JP); Fumio Kato, Osaka (JP)

(21) Appl. No.: 13/482,202

(22) Filed: May 29, 2012

(30) Foreign Application Priority Data
Jul. 12, 2011 (JP) 2011-153578

(51) Int. Cl. H01M 10/28; H01M 10/52; H01M 2/12; H01M 2/16; H01M 2/02; H01M 4/42

(52) U.S. Cl. 429/82; 429/164; 429/128

(57) ABSTRACT

An alkaline secondary battery including: a hollow cylindrical positive electrode; a negative electrode containing zinc as an active material; a separator arranged between the positive electrode and the negative electrode; an alkaline electrolytic solution; and a battery case containing the positive electrode, the negative electrode, the separator, and the alkaline electrolytic solution, wherein the positive electrode has a porosity of 34% or higher, and the separator is a hydrophilized microporous polyolefin film.

### CROSS-REFERENCE TO RELATED APPLICATION

This application claims priority to Japanese Patent Application No. 2011-153578 filed on Jul. 12, 2011, the disclosure of which including the specification, the drawings, and the claims is hereby incorporated by reference in its entirety.

### BACKGROUND

Reuse of alkaline batteries, which are primary batteries disposed after use, has been demanded from the viewpoint of saving resources. Used alkaline batteries can be charged and reused in theory (see, e.g., WO 94/24718). However, when the alkaline battery which is designed as the primary battery is charged, gas is generated in the battery, and an electrolytic solution is leaked from the battery. A general alkaline battery includes a safety valve for releasing the gas in the battery when pressure in the battery increases, and the electrolytic solution is leaked together with the gas when the safety valve is operated. Different from the alkaline batteries, alkaline secondary batteries are chargeable.

Alkaline secondary batteries are designed to be charged safely using an exclusive charger. However, when a user erroneously charges the alkaline secondary battery, for example, with a fast charger for nickel hydrogen batteries without a voltage control function, a large amount of gas is generated in the battery during the charge, and the pressure in the battery increases. This may cause leakage of the electrolytic solution.

### SUMMARY

An alkaline secondary battery of the present disclosure includes a hollow cylindrical positive electrode, a negative electrode containing zinc as an active material, a separator arranged between the positive electrode and the negative electrode, an alkaline electrolytic solution, and a battery case containing the positive electrode, the negative electrode, the separator, and the alkaline electrolytic solution. The positive electrode has a porosity of 34% or higher, and the separator is a hydrophilized microporous polyolefin film.

The disclosed alkaline secondary battery can prevent accumulation of gas in the battery even when the battery is erroneously charged, thereby reducing increase in pressure in the battery, and preventing leakage of the electrolytic solution.

### BRIEF DESCRIPTION OF THE DRAWINGS

FIG. 1 is a partial cross-sectional view of an alkaline secondary battery according to an embodiment of the present disclosure.

FIG. 2 shows voltage behavior observed when a conventional alkaline secondary battery which has never been discharged is charged at a constant current.

FIG. 3 shows voltage behavior observed when a conventional alkaline secondary battery which has been charged and discharged is charged at a constant current.

FIG. 4 shows voltage behavior observed when an alkaline secondary battery of the present disclosure is charged at a constant current.

### DETAILED DESCRIPTION

An embodiment of the present disclosure will be described in detail below with reference to the drawings. The present disclosure is not limited to the following embodiment.

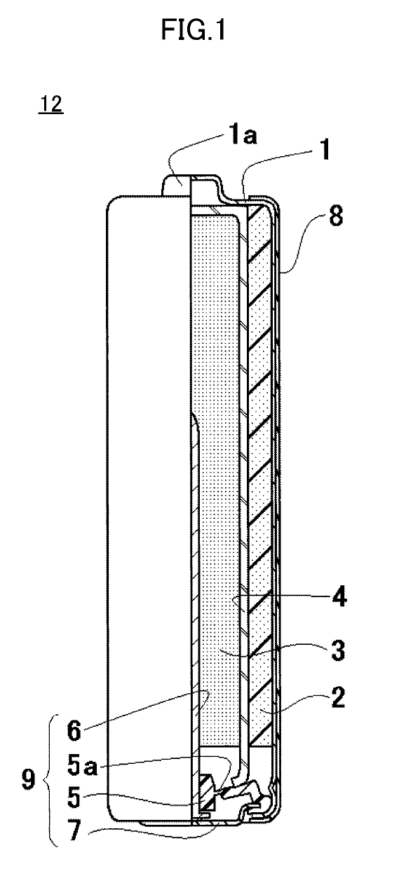

FIG. 1 is a partial cross-sectional view of an alkaline secondary battery according to an embodiment of the present disclosure. A hollow cylindrical positive electrode 2 containing manganese dioxide as an active material is contained in a battery case 1 which also functions as a positive electrode terminal 1a so that the positive electrode 2 contacts an inner surface of the battery case 1. A negative electrode 3 containing zinc as an active material is placed in a hollow part of the positive electrode 2 with a separator 4 interposed therebetween. An opening of the battery case 1 is sealed with a sealing unit 9 including a negative electrode terminal 7 electrically connected to a negative electrode current collector 6, and a gasket 5 having a safety valve 5a. An outer surface of the battery case 1 is covered with an outer label 8.

How the inventors have achieved the present disclosure will be described below before describing the present disclosure.

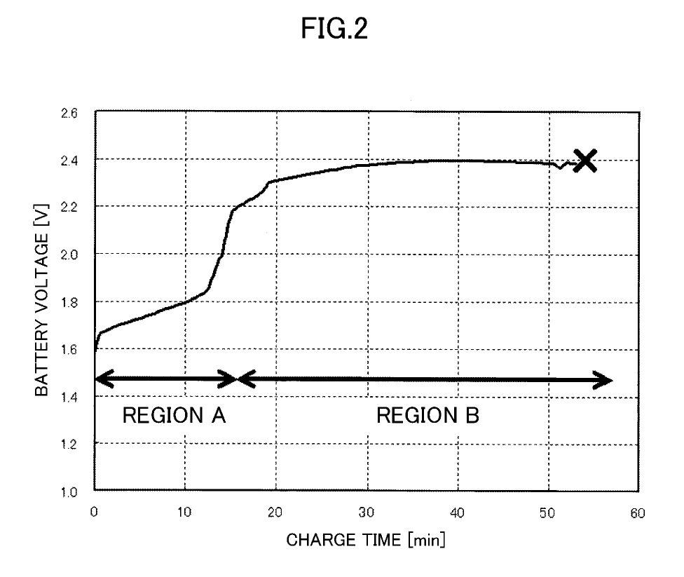

FIG. 2 shows voltage behavior observed when a conventional alkaline secondary battery which has never been discharged is charged at a constant current.

In region A in FIG. 2, a charge reaction of zinc occurred in the negative electrode, and a charge reaction of manganese dioxide occurred in the positive electrode as represented by formulae (1) and (2).

Negative electrode: Zn(OH)₄²⁻+2e⁻→Zn+4OH⁻ (1)

Positive electrode: MnOOH+OH⁻→MnO₂+H₂O+e⁻ (2)

When reduction of zincate represented by the formula (I) was finished, a potential of the negative electrode increased, and then reduction of water represented by a formula (3) started in the negative electrode (region B). Specifically, in region B, the reactions in the negative and positive electrodes occurred as represented by the formulae (3) and (2).

Negative electrode: 2H₂O+2e⁻H₂↑+2OH (3)

Positive electrode: MnOOH+OH⁻→MnO₂+H₂O+e⁻ (2)

Then, when oxidation of the positive electrode was finished, oxygen generation represented by a formula (4) started in the positive electrode.

Negative electrode: 2H₂O+2e⁻H₂↑+2OH (3)

Positive electrode: 4OH⁻→O₂↑+2H₂O+4e⁻ (4)

Hydrogen was generated by the reaction of the formula (3), and oxygen was generated by the reaction of the formula (4). Thus, gas was accumulated in the battery, and pressure in the battery increased. Then, leakage of an electrolytic solution occurred at point X in FIG. 2.

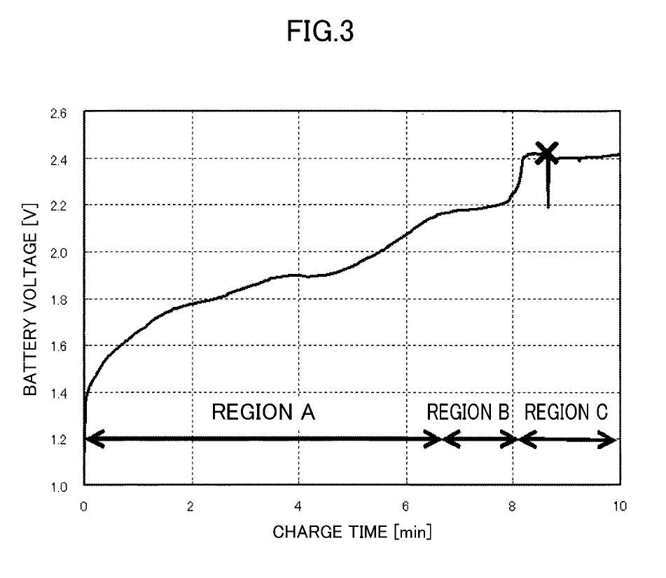

FIG. 3 shows voltage behavior observed when the same alkaline secondary battery as FIG. 2 which has been charged and discharged several times in advance is charged at a constant current.

In region A in FIG. 3, charge reactions occurred in the positive and negative electrodes as represented by the formulae (1) and (2) like in the non-discharged battery. However, in the battery which had previously been discharged, a by-product of the discharge had been generated in the positive electrode. Thus, different from the non-discharged battery, the positive electrode was charged faster than the negative electrode.

When the charge of manganese dioxide was finished, the oxygen generation represented by the formula (4) started in the positive electrode, and the voltage remained approximately constant around 2.2 V (region B). Specifically, the following reactions occurred in the positive and negative electrodes in region B.

Negative electrode: Zn(OH)₄²⁻+2e⁻→Zn+4OH⁻ (1)

Positive electrode: 4OH⁻→O₂↑+2H₂O+4e⁻ (4)

When reduction of zincate in the negative electrode was finished, the voltage increased to about 2.4 V, and hydrogen was generated in the negative electrode (region C). Specifically, the following reactions occurred in the positive and negative electrodes in region C.

Negative electrode: 2H₂O+2e⁻H₂↑+2OH (3)

Positive electrode: 4OH⁻→O₂↑+2H₂O+4e⁻ (4)

Hydrogen was generated by the reaction of the formula (3), and oxygen was generated by the reaction of the formula (4). Thus, gas was accumulated in the battery, and pressure in the battery increased. Then, leakage of an electrolytic solution occurred at point X in FIG. 3.

The above results indicate that the leakage occurs when the conventional alkaline secondary battery is erroneously charged, irrespective of whether the battery has never been discharged, or has been charged and discharged in advance.

The inventors presumed that if the oxygen generated by the reaction of the formula (4) in the positive electrode is transferred to the negative electrode, oxygen consumption occurs in the negative electrode as represented by a formula (5), thereby reducing the accumulation of the gas in the battery, and preventing the increase in pressure in the battery.

2H₂O+O₂+4e⁻→4OH⁻ (5)

The inventors have found that the reaction of the chemical formula (4) generates oxygen in the positive electrode near an inner surface of the battery case. When a charge current flows through the positive electrode, resistance of the positive electrode exits. Presumably, electronic resistance and ion diffusion resistance of the positive electrode increase in a direction from the separator to the battery case, thereby causing polarization. Thus, a potential of the positive electrode increases with decreasing distance from the battery case where the resistance is high. As a result, the reaction of the formula (5) easily occurs.

Then, the inventors presumed that the reaction of the formula (5) could occur in the negative electrode if the oxygen generated near the inner surface of the battery is transferred to the negative electrode through the positive electrode and the separator. Specifically, when the reaction of the chemical formula (5) starts in the negative electrode, the generation of hydrogen in the negative electrode stops, and the oxygen generated in the positive electrode is consumed in the negative electrode. This can reduce the accumulation of the gas in the battery. It is presumed that the oxygen is transferred in the form of dissolved oxygen in the electrolytic solution.

Based on the findings, the inventors presumed that porosity of the positive electrode and material of the separator are key factors to allow the oxygen generated near the inner surface of the battery case to reach the negative electrode through the positive electrode and the separator. Then, the inventors fabricated alkaline secondary batteries having the positive electrodes of different porosities and using different materials of the separator to check whether the leakage occurs or not when the batteries are erroneously charged.

The alkaline secondary batteries were AA batteries as shown in FIG. 1, and were fabricated in the following manner.

### (Fabrication of Positive Electrode 2)

Electrolytic manganese dioxide powder and graphite powder were mixed in a mass ratio of 94:6. To 100 parts by mass of the mixed powder, 2 parts by mass of an alkaline electrolytic solution was added and mixed uniformly, and the mixture was granulated to a uniform particle size. The alkaline electrolytic solution used was a 40% by mass potassium hydroxide aqueous solution containing 2% by mass of zinc oxide.

The mixed powder particles are press-molded to obtain a hollow cylindrical positive electrode pellet. An amount of the mixed powder per pellet was changed to prepare five types of pellets having porosities of 30%, 32%, 34%, 36%, and 38%, respectively.

Two positive electrode pellets of the same porosity were inserted in the battery case 1, and pressed to bring the positive electrode pellets into close contact with an inner surface of the battery case 1 to obtain the positive electrode 2.

### (Fabrication of Separator 4)

Two types of the separator 4 were prepared. One was a microporous polyethylene film (manufactured by Asahi Kasei Corporation) which was hydrophilized by sulfonation, and the other was a stack of nonwoven fabric made of vinylon-lyocell composite fiber (manufactured by Kuraray Co., Ltd.) and cellophane (manufactured by Futamura Chemical Co., Ltd.). Each of the separators 4 was rolled into a cylindrical shape and an end thereof was closed with an adhesive, and inserted in a hollow part of the positive electrode 2 with the closed end facing down. Then, an alkaline electrolytic solution was poured into a hollow part of the cylindrical separator 4.

### (Fabrication of Negative Electrode 3)

Zinc alloy powder containing Al (0.05% by mass), Bi (0.015% by mass), and In (0.02% by mass) was prepared by gas atomization. The prepared zinc alloy powder was classified to have a specific surface area of 0.038 cm²/g measured by the BET method.

A gelled alkaline electrolytic solution was prepared by mixing 50 parts by mass of an alkaline electrolytic solution, 0.18 parts by mass of crosslinked polyacrylic acid, and 0.35 parts by mass of crosslinked sodium polyacrylate. The obtained gelled alkaline electrolytic solution and 100 parts by mass of the zinc allow powder were mixed to prepare a gelled negative electrode 3, and poured into the hollow part of the separator 4.

The alkaline electrolytic solution used was a 40% by mass potassium hydroxide aqueous solution containing 2% by mass of zinc oxide. A molar concentration of potassium hydroxide in the electrolytic solution was 10.66 mol/L.

### (Fabrication of Alkaline Secondary Battery)

An opening of the battery case 1 was sealed with a sealing unit 9 including a negative electrode terminal 7 electrically connected to a negative electrode current collector 6, and a resin gasket 5 having a safety valve 5a, and then an outer surface of the battery case 1 was covered with an outer label 8.

Table 1 shows results of a test conducted on alkaline secondary batteries having different porosities of the positive electrode, and using different separator materials to see whether the batteries cause leakage when the batteries are erroneously charged.

TABLE 1

| | Structure of battery | | |
|---|---|---|---|
| | Porosity of | | Results |
| | positive electrode | | Number of batteries caused |
| No. | [%] | Separator | leakage after charge test |
| A1 | 30 | Microporous | 5 |
| B1 | 32 | polyethylene | 4 |
| C1 | 34 | film | 0 |
| D1 | 36 | | 0 |
| E1 | 38 | | 0 |
| A2 | 30 | Nonwoven | 5 |
| B2 | 32 | fabric + | 5 |
| C2 | 34 | cellophane | 5 |
| D2 | 36 | | 5 |
| E2 | 38 | | 5 |

Porosity v was calculated from the following formula in which V1 is a sum total of volumes of substances constituting the positive electrode, and V2 is an occupied volume of the positive electrode.

$$v = \frac{V 2 - V 1}{V 2} \times 100 \qquad ( Formula 1 )$$

Suppose that mass and density of a substance i constituting the positive electrode are Wi and Di, respectively, V1 is calculated from the following formula.

$$V 1 = {\sum }_{i} \frac{{W}_{i}}{{D}_{i}} \qquad ( Formula 2 )$$

For example, manganese dioxide as the active material has a density of 4.40 g/cm³, and graphite as a conductive agent has a density of 2.26 g/cm³.

V2 is calculated from the following formula by measuring an outer diameter r1, an inner diameter r2, and a height h of the hollow cylindrical positive electrode from an X-ray image.

$$V 2 = \frac{π}{4} ( {r}_{2}^{2} - {r}_{1}^{2} ) h \qquad ( Formula 3 )$$

Whether the alkaline secondary batteries cause the leakage or not was checked 8 hours after continuous charge of the prepared batteries, 5 each, at a constant current of 350 mA at room temperature.

As shown in Table 1, batteries C1, D1, and E1 having the porosity of the positive electrode of 34% or higher, and using the microporous polyethylene film as the separator did not cause the leakage. However, batteries A1 and B2 having the porosity of the positive electrode of 32% or lower caused the leakage even when the microporous polyethylene film was used as the separator. Batteries A2, B2, C2, D2, and E2 using the two-layered separator made of the nonwoven fabric and the cellophane caused the leakage even when the porosity of the positive electrode was increased to 38%.

A possible cause of the results is as follows. Specifically, when the porosity of the positive electrode is 34% or higher, sufficient pores are provided in the positive electrode. Thus, dissolved oxygen generated near the inner surface of the battery case 1 can smoothly move to the separator 4 through the pores in the positive electrode 2.

In addition, when the separator 4 is made of the hydrophilized microporous polyolefin film having sufficient hydrophilicity and pores, the dissolved oxygen which moved to the separator 4 through the positive electrode 2 can smoothly pass through the separator 4 to reach the negative electrode 3.

Regarding the alkaline secondary battery including the battery case 1 containing the hollow cylindrical positive electrode 2, the negative electrode 3 containing zinc as the active material, the separator 4 arranged between the positive electrode 2 and the negative electrode 3, and the alkaline electrolytic solution, it is considered based on the foregoing that the accumulation of the gas in the battery can be prevented, and the increase in pressure in the battery can be reduced even when the battery is erroneously charged by setting the porosity of the positive electrode 2 to 34% or higher, and using the hydrophilized microporous polyethylene film as the separator 4. This can prevent the leakage of the electrolytic solution.

When the separator 4 is made of a microporous polyolefin film, such as a microporous polypropylene film, instead of the microporous polyethylene film, similar advantages can be obtained. The microporous polyolefin film is a polymer of hydrocarbon having a single carbon-carbon double bond, and has a pore diameter sufficient to allow the dissolved oxygen to penetrate the separator.

A method for hydrophilizing the separator is not particularly limited. For example, plasma treatment may be performed instead of the sulfonation.

To study the number of the pellets constituting the positive electrode 2, batteries D3 and D4 in which the positive electrodes 2 were made of three pellets and four pellets, respectively, were fabricated. Batteries D3 and D4 were fabricated in the same manner as D1 (using two pellets) except for the number of the pellets.

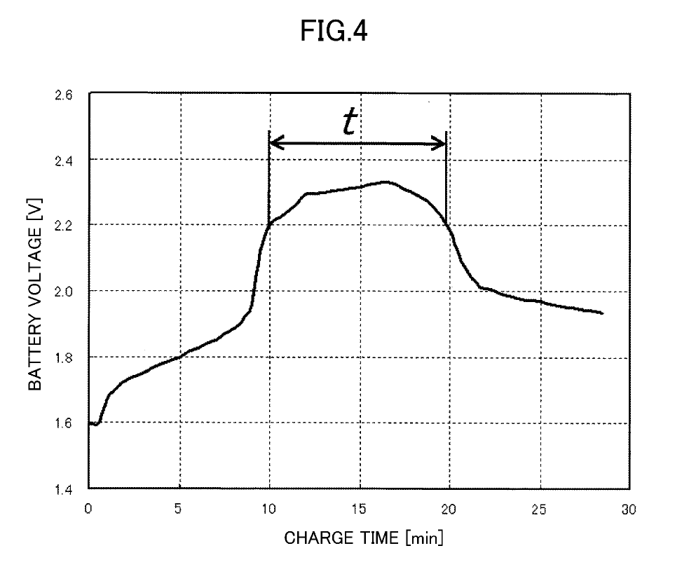

FIG. 4 shows voltage behavior of batteries D3 and D4 continuously charged at a constant current of 350 mA.

As shown in FIG. 4, the voltage rapidly increased after a lapse of 10 minutes from the start of the charge, and the voltage remained 2.2 V or higher for about 10 minutes, and then the voltage was reduced. It is presumed that hydrogen gas was accumulated in the battery during time t for which the voltage remained 2.2 V or higher. Specifically, according to the present disclosure, when the oxygen generation of the formula (4) starts in the positive electrode 2, the oxygen moves to the negative electrode 3, and the oxygen consumption of the formula (5) starts in the negative electrode 3. Thus, the accumulation of the gas in the battery is stopped, and the voltage drops.

Table 2 shows the results of measurement of time t shown in FIG. 4 on batteries in which the number of the pellets constituting the positive electrode 2 was varied.

TABLE 2

| | | Results |
|---|---|---|
| | Structure of battery | Time t |
| No. | Number of pellets | [min] |
| D1 | 2 | 10 |
| D3 | 3 | 8 |
| D4 | 4 | 7 |

As shown in Table 2, time t was reduced as the number of the pellets in the positive electrode 2 increased. When the number of the pellets increases, gaps between the pellets increase. Thus, it is presumed that the dissolved oxygen was able to smoothly move to the separator 4 through the gaps, thereby reducing time for transition from the oxygen generation of the formula (4) to the oxygen consumption of the formula (5). Thus, in view of reduction of the accumulation of the gas in the battery, the larger number of the pellets constituting the positive electrode 2 is more preferable. This can effectively prevent the leakage of the electrolytic solution even when the battery is erroneously charged.

When time t is 8 minutes or less, the amount of the gas accumulated in the battery can be reduced to 20 ml or less. Depending on the rest of space in the battery, or conditions for operating the safety valve, 20 ml of the gas corresponds to half of the pressure at which the safety valve is operated. Thus, the safety valve is not operated yet when the amount of the accumulated gas is 20 ml or less. For this reason, the number of the pellets constituting the positive electrode 2 is preferably three or more as shown in Table 2.

To study a concentration of the electrolytic solution, batteries D5 and D6 were fabricated in which molar concentrations of potassium hydroxide (KOH) in the electrolytic solution was 10.00 mol/L and 10.50 mol/L, respectively. The batteries were fabricated in the same manner as battery D1 (the molar concentration of potassium hydroxide in the electrolytic solution was 10.66 mol/L) except for the molar concentration of potassium hydroxide in the electrolytic solution.

Like Table 2, Table 3 shows the results of measurement of time t shown in FIG. 4 on batteries fabricated by changing the molar concentration of potassium hydroxide in the electrolytic solution.

TABLE 3

| | Structure of battery | |
|---|---|---|
| | Molar concentration of KOH in | Results |
| | alkaline electrolytic solution | Time t |
| No. | [mol/L] | [min] |
| D5 | 10.00 | 6.5 |
| D6 | 10.50 | 8 |
| D1 | 10.66 | 10 |

As shown in Table 3, time t was reduced as the molar concentration of potassium hydroxide in the electrolytic solution was reduced. The solubility of oxygen in the electrolytic solution increases as the molar concentration of potassium hydroxide is reduced. Thus, it is presumed that the oxygen generated near the inner surface of the battery case was dissolved in the electrolytic solution, and the dissolved oxygen was able to quickly move to the negative electrode through the positive electrode and the separator, thereby reducing time for transition from the oxygen generation of the formula (4) to the oxygen consumption of the formula (5).

Thus, in view of reduction of the accumulation of the gas in the battery, the lower molar concentration of potassium hydroxide in the electrolytic solution is more preferable. This can effectively prevent the leakage of the electrolytic solution even when the battery is erroneously charged. The molar concentration of potassium hydroxide is more preferably 10.5 mol/L or lower because time t can be 8 minutes or less as shown in Table 3, and the amount of the gas accumulated in the battery can be reduced to 20 ml or less.

To study a specific surface area of the zinc powder in the negative electrode 3, batteries D7 and D8 in which the specific surface areas of the zinc powder were 0.040 cm²/g and 0.045 cm²/g, respectively, were fabricated. The batteries were fabricated in the same manner as battery D1 (the specific surface area of the zinc powder was 0.038 cm²/g) except for the specific surface area of the zinc powder. The specific surface area of the zinc powder was measured by the BET method.

Like Table 2, Table 4 shows the results of measurement of time t shown in FIG. 4 on batteries fabricated by changing the specific surface area of the zinc powder in the negative electrode 3.

TABLE 4

| | Structure of battery | Results |
|---|---|---|
| | Specific surface area of zinc | Time t |
| No. | powder [cm²/g] | [min] |
| D1 | 0.038 | 10 |
| D7 | 0.040 | 7.5 |
| D8 | 0.045 | 7 |

As shown in Table 4, time t was reduced as the specific surface area of the zinc powder increased. When the specific surface area of the zinc powder increases, a surface area of the negative electrode increases. Thus, it is presumed that the dissolved oxygen which passed through the positive electrode and the separator was able to quickly reach the surface of the negative electrode, thereby reducing time for transition from the oxygen generation of the formula (4) to the oxygen consumption of the formula (5).

Thus, in view of reduction of the accumulation of the gas in the battery, the larger specific surface area of the zinc powder is more preferable. This can effectively prevent the leakage of the electrolytic solution even when the battery is erroneously charged. The specific surface area of the zinc powder is more preferably 0.04 cm²/g or more because time t can be 8 minutes or less as shown in Table 4, and the amount of the gas accumulated in the battery can be reduced to 20 ml or less.

The present disclosure is not limited to the preferred embodiment described above, and can be modified in various ways. For example, manganese dioxide has been used as the active material of the positive electrode 2 in the above embodiment. However, the active material is not limited thereto, and similar advantages can be obtained when another active material, such as nickel hydroxide, is used. On the hydrophilized microporous polyolefin film used as the separator, nonwoven fabric may be stacked so that a larger amount of the electrolytic solution can be held.

What is claimed is:

1. An alkaline secondary battery comprising:
a hollow cylindrical positive electrode;
a negative electrode containing zinc as an active material;
a separator arranged between the positive electrode and the negative electrode;
an alkaline electrolytic solution; and
a battery case containing the positive electrode, the negative electrode, the separator, and the alkaline electrolytic solution, wherein
the positive electrode has a porosity of 34% or higher, and
the separator is a hydrophilized microporous polyolefin film.

2. The alkaline secondary battery of claim 1, wherein
the positive electrode is made of three or more pellets.

3. The alkaline secondary battery of claim 1, wherein
the alkaline electrolytic solution has a molar concentration of 10.5 mol/L or lower.

4. The alkaline secondary battery of claim 1, wherein
the zinc is zinc powder having a specific surface area of 0.04 cm²/g or more.

5. The alkaline secondary battery of claim 1, wherein
the battery has a safety valve for releasing gas generated in the battery outside the battery.
